(19) United States
(12) Patent Application Publication
(10) Pub. No.: US 2016/0092836 A1
(43) Pub. Date: Mar. 31, 2016

(54) Transportation Network Solution

(71) Applicant: David Samuel Alioto, Tipp City, OH (US)

(72) Inventor: David Samuel Alioto, Tipp City, OH (US)

(21) Appl. No.: 14/873,181

(22) Filed: Oct. 1, 2015

Related U.S. Application Data
(60) Provisional application No. 62/056,677, filed on Sep. 29, 2014.

(51) Int. Cl. G06Q 10/08

(52) U.S. Cl. CPC G06Q 10/08345

(57) ABSTRACT

The Transportation Network Solution “TNS” represents a major innovation to the current transportation management processes, technologies and networks that procure transportation based on carrier provided contract rates. The TNS Benchmark Rate Table, TNS Rule Engine and the TNS Transportation Providers Network comprise an integrated process to enable a Shipper to secure transportation capacity in a more cost competitive and comprehensive basis. The Transportation Network Solution “TNS” offers several compelling benefits to the Shipper. The TNS Benchmark Rate Table enables the Shipper to establish the rates they would like to pay for LTL and truckload transportation—manually or automatically. The net result is a predefined savings level on any tender accepted by the TNS Transportation Network Providers Network—lowering the Shipper's transportation costs. The Shipper can implement the Transportation Network Solution “TNS” without any modifications to their ERP or TMS.

### FIELD OF INVENTION

The Transportation Network Solution “TNS” relates to a method and system that enables a more efficient rating, integration and allocation of truckload and less than truckload “LTL” orders from Shippers to larger transportation networks. More particularly, the TNS is a process that allows the establishment of benchmark rates by the Shipper at various discount levels to their existing pricing and then automates the securing of transportation services, LTL and full truckload, via a single integration point to a vast transportation network.

### BACKGROUND OF THE INVENTION

The majority of larger Shippers utilize a process for tendering LTL and truckload shipments to transportation providers that is driven off an allocation process that resides within their Enterprise Resource Planning “ERP” system or their Transportation Management System “TMS”. The standard process involves Shippers securing rates from various transportation concerns. The rates will specify a cost (e.g., by lb., per mile or volume) to move a commodity from an origin point to a destination point. The Shipper may designate the origin point or destination point by zip code (three digits or five digits) or other geographic value—such as a state area.

The Shipper will then load the transportation rates into their ERP or TMS. The standard process is for the contract rates for each transportation provider to reside within a rate table within the ERP or TMS. A larger Shipper will usually have hundreds of contract rates with different transportation providers residing within their ERP or TMS environment.

Upon the designation of a customer order for shipment, the standard process is for the ERP or TMS to access the rate tables and automatically tier the transportation providers contract rates from the lowest cost to the highest cost—based on the service requirements of the order. The ERP or TMS will then first tender the shipment to the lowest cost transportation provider (Carrier One) based on their existing contract rates. Carrier One will then have the option to accept or reject the order based on their available capacity. In the event that Carrier One rejects the shipment, the ERP or TMS will then tender the shipment to the next most competitive transportation provider in the cost sequence (Carrier Two) for accept or reject of the shipment. Overall, the tendering sequence will continue until the final acceptance by a transportation provider.

The key benefit of this transportation management process is insuring that the low cost provider is selected based on the contract rates in place between the Shipper and their transportation providers. In addition, the process usually involves the use of electronic file formats that allow for efficient communication of the shipment detail between the Shipper and transportation provider—versus phone calls or faxing of the shipment information.

The Transportation Network Solution “TNS” provides another level of innovation and efficiency that supersedes the capabilities of the existing ERP & TMS transportation processes in the following key areas: establishment of pricing parameters and securing of transportation capacity.

The standard pricing model is for the Shipper to receive contract rates from each transportation provider. Effectively, the transportation rates are “static” that the Shipper receives from each transportation provider per a certain time period. The transportation provider provides pricing to the Shipper based on their average operating costs for a set regional area or lane within their transportation network. However, on a daily basis the LTL and truckload transportation providers experience changes in capacity based on the movement of trucking assets throughout their network. The TNS enables the Shipper to secure additional savings or capacity by leveraging the fluctuations in available transportation capacity.

By utilizing the TNS process, a Shipper can set the pricing benchmarks for each lane or regional area that they want to pay for an LTL or truckload movement as opposed to operating off of the transportation provider's contract rates. Most importantly, the Shipper has the ability to immediately adjust their rates at their own discretion. The pricing benchmarks reside in the TNS Benchmark Rate Table. The pricing is either manually created by the Shipper or automatically developed by the TNS Rules Engine per the Shipper's desired discount or service criteria.

As a next step, the TNS enables the Shipper to tender via their own rate benchmarks via a single interface to a network of over 12,000 transportation providers—the TNS Transportation Provider Network.

The TNS process provides the Shipper the following substantive benefits:

1. The Shipper can establish their own pricing benchmarks for allocation of orders in the TNS Benchmark Rate Table. The Shipper is no longer governed by the contract rates provided by their transportation providers. The Shipper can establish pricing benchmarks that are lower than the transportation provider(s) contract rates enabling further reduction in their overall freight costs.

2. The Shipper can then tender their benchmark rates via a single interface to the TNS Transportation Provider Network. The TNS Transportation Provider Network enables the Shipper's tender to be viewed by over 12,000 transportation firms in a simultaneous fashion for accept or reject per the Shipper's pricing benchmarks.

3. The TNS Rules Engine software application adjusts the rate contained within the

Shipper's Shipment Data File after it is generated by the Shipper's ERP or TMS—automating the creation of a benchmark rate for tendering to the TNS Transportation Providers Network. The TNS Rules Engine also captures information regarding the acceptance rate of tenders and can automate the adjustment of pricing to improve the ratio of acceptance by the TNS Network.

### SUMMARY OF THE INVENTION

The method and the system of this invention center around the innovative concept of enabling the Shipper to set their own benchmark rates for transportation services, coupled with the ability to tender simultaneously to a comprehensive transportation network in order to secure additional transportation savings and capacity.

The invention is comprised of following three key components:

1. TNS Benchmark Rate Table: The TNS Benchmark Rate Table is an adjustable rate framework and database. The TNS Benchmark Rate Table is comprised of Shipper determined transportation rates categorized by origin point, destination point, cost per mile, cost per lb., equipment type and service level. The TNS Benchmark Rate Table can reside within the Shipper's ERP/TMS or within the TNS Rules Engine. The pricing for all TNS shipments reside in the TNS Benchmark Rate Table.

2. TNS Rules Engine: The TNS Rules Engine is a software program that interfaces with the Shipper's ERP or TMS, TNS Benchmark Rate Table and the TNS Transportation Providers Network. The TNS Rules Engine reads shipment data file records sent via EDI or other file formats from the Shippers ERP or TMS, adjusts pricing data fields or service requirements to the Shipper's benchmark criteria and then tenders the orders to the TNS Transportation Providers Network. The TNS Rules Engine also contains a database of the Shipper's benchmark pricing and shipment transaction detail for reporting purposes. The TNS Rules Engine enables the Shipper to automate the refinement of their pricing to improve acceptance of transportation tenders. The TNS Rules Engine also transmits shipment status information to the Shipper.

3. TNS Transportation Providers Network: The TNS Transportation Providers Network is comprised of over 12,000 LTL and truckload carriers that operate under agreement as service providers for the TNS Program. The LTL and truckload providers accept or reject tender requests from the Shippers participating in the TNS Program.

### DESCRIPTION OF THE DRAWINGS

A clear understanding of the key features of the invention summarized above may be had by reference to the drawings FIG. 1 TRANSPORTATION NETWORK SOLUTION “TNS” PROCESS and FIG. 2 TNS BENCHMARK RATE TABLE, which illustrate the method and system of the invention. The Drawings depict preferred embodiments of the invention and, therefore, is not to be considered as limiting its scope with regard to other embodiments which the invention is capable of contemplating. Accordingly:

FIG. 1: TRANSPORTATION NETWORK SOLUTION “TNS” PROCESS

1. Represents the Shipper's Enterprise Resource Planning System “ERP” system.

The ERP system is business management software that is an integrated application for managing key activities such as product planning, manufacturing, marketing & sales, inventory management and shipping. The majority of Fortune 500 companies utilize ERP systems from market leading companies such as SAP and Oracle.

2. Represents the Shipper's Transportation Management System “TMS”. The TMS is a standalone application or a subset of the ERP system. The TMS manages key processes of transportation management focused primarily on the planning, optimization and selection of transportation mode/provider.

3. Designates the Shipper's shipment data file which is generating in an electronic file format from the ERP system or TMS and transmitted to the TNS Rules Engine or directly to the TNS Transportation Providers Network.

4. Represents the software program which comprises the TNS Rules Engine. The TNS Rules Engine reads shipment data file records, adjusts pricing data fields or service requirements to Shipper benchmark criteria and then tenders the orders to the TNS Transportation Providers Network. The TNS Rules Engine also contains a database of the Shipper's benchmark pricing and shipment transaction detail for reporting purposes. The TNS Rules Engine also transmits shipment status information to the Shipper.

5. The TNS Benchmark Rate Table which is comprised of Shipper determined transportation rates categorized by origin point, destination point, cost per mile, cost per lb., equipment type and service level.

6. Designates the TNS Shipment Data File which is comprised of all the shipment detail including the TNS benchmark rate and formatted for tendering to the TNS Transportation Providers Network.

7. Reflects the process in which the Shipment Data File is transmitted to the TNS Transportation Providers Network to determine if the shipment is: 1) Accepted for movement by a transportation provider within the TNS Transportation Providers Network or, 2) Rejected for movement within the TNS Transportation Providers Network.

8. Represents the TNS Transportation Providers Network that is comprised of over 12,000 LTL and truckload carriers.

9. Designates the shipment status information that is transmitted by the carrier directly to the Shipper's ERP or TMS as well as the TNS Rules Engine.

10. Invoice record of transportation charges for movement of the shipment as part of the TNS Program for transmittal to the Shipper.

FIG. 2: TNS BENCHMARK RATE TABLE

The TNS Benchmark Rate Tables is a data structure and framework that incorporates the functionality for the Shipper to establish benchmark rates and designate service level, equipment type and destination points:

1. Key Contact Information of Shipper.

2. Origin of Shipping Location.

3. Service Type: Van, Flatbed or Refrigerated Transportation.

4. Equipment Type: Designation of Trailer Size as it relates to Van, Flatbed or Refrigerated Transportation.

5. Destination State Points in which the rates will apply.

6. Destination Five Digit Zip Code Area in which the rates will apply. 7. Minimum Charge Rate determined by Shipper.

8. Cost Per Mile rate determined by Shipper.

### DESCRIPTION OF THE INVENTION

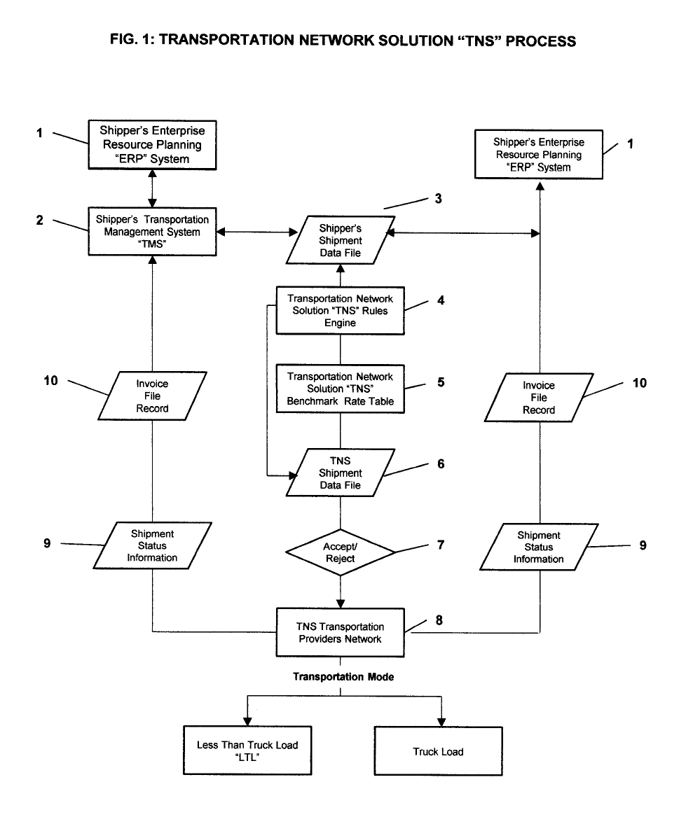

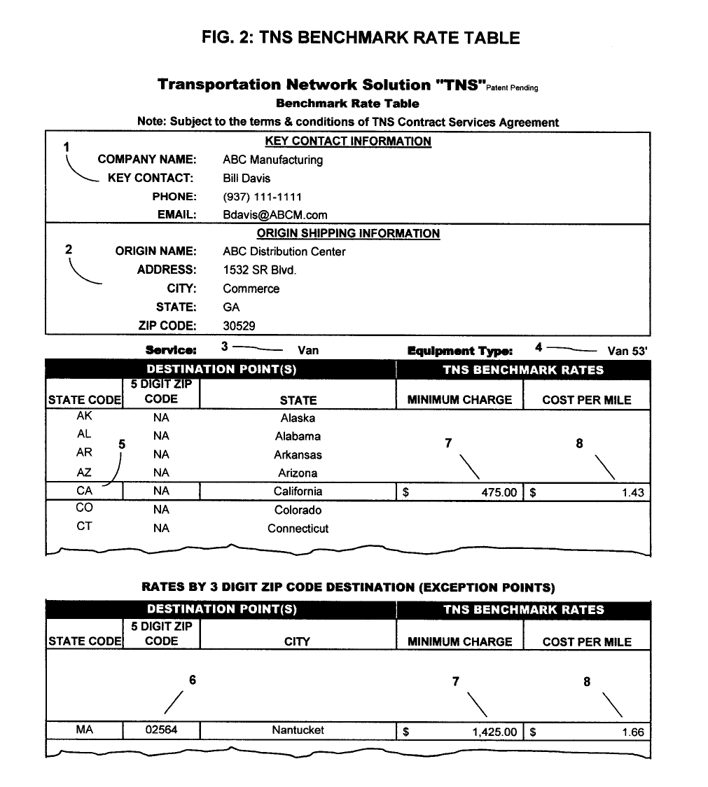

The Shipper will designate an order for shipment within their ERP (FIG. 1, No. 1) or TMS (FIG. 1, No. 2) creating a shipment data file (FIG. 1, No. 3). The shipment data file will then be transmitted to the TNS Rules Engine (FIG. 1: No. 4) in which the Shipper's rate for this shipment will be calculated through a query of the TNS Benchmark Rate Table (FIG. 1: No. 5).

The TNS Benchmark Rate Table (FIG. 2) enables the shipper to determine the origin shipping point (FIG. 2: No. 2), service type (FIG. 2: No. 3) and equipment type (FIG. 2: No. 4). The Shipper then determines the destination shipping points by state (FIG. 2: No. 5) or zip code (FIG. 2: No. 6). Also, the Shipper sets the rate they would like to pay (FIG. 2: No. 7, No. 8).

The Shipper has the option to manually populate the TNS Benchmark Rate Table or have the TNS Rules Engine automatically adjust each shipment data file (FIG. 1, No. 3) by the discount level determined by the Shipper.

The TNS Rules Engine enables the Shipper to set a discount level that will apply to each shipment data file (tender) generated from their ERP or TMS—creating a discounted benchmark rate per each shipment data file. The Shipper can set a discount level that applies to all their shipments or refined to a specific geographic area.

The TNS Rules Engine reads the shipment data file (tender) of the Shipper and applies a discount mutator to the cost field of the tender, stores the modified tender in the TNS Rules Engine database and creates the TNS Shipment Data File (See FIG. 1, No. 6). A TNS Shipment Data File will then be generated by the TNS Rules Engine that incorporates the Shipper's designated benchmark pricing. The TNS Shipment Data File is tendered to the TNS Transportation Providers Network (FIG. 1, No. 8) via an electronic file format for accept or reject of the shipment (FIG. 1, No. 8). The TNS Transportation Providers Network is comprised of 12,000 contracted carriers that review the TNS Shipment Data File via a web interface. The carrier will then determine whether they can move the shipment based on the Shipper established benchmark pricing, available capacity and service requirement of the order. The shipment status information (FIG. 1, No. 9) is transmitted to the Shipper's ERP or TMS that denotes accept/reject of the shipment as well as key status updates such as date of pickup, delivery date, etc. An invoice of the freight charges is transmitted to the Shipper (FIG. 1, No. 10).

The TNS Rule Engine maintains a database of all shipment tenders, benchmark rate per each tender and associated accept/reject rate per tender. The TNS Rules Engine enables the Shipper to automatically set benchmark pricing based on their preferred discount level to existing contract rates and other variables such as desired acceptance rate percentage of shipments tendered to the TNS Transportation Providers Network.

The embodiments of the invention in which an exclusive property or privilege is claimed are defined as follows:

1. The integrated process and software wherein a Shipper can automatically develop their own benchmark rates for LTL and truckload transportation service and electronically tender to vast transportation network.

2. The TNS Benchmark Table wherein a Shipper can set and adjust their preferred pricing and service criteria for LTL and Truckload Transportation.

3. The TNS Rules Engine wherein the Shipper can automatically adjust the pricing of LTL and Truckload shipment tenders generated from their existing TMS and ERP systems.
